(19) United States
(12) Patent Application Publication
(10) Pub. No.: US 2022/0116782 A1
(43) Pub. Date: Apr. 14, 2022

(54) COMPROMISED MOBILE DEVICE DETECTION SYSTEM AND METHOD

(71) Applicant: Qatar Foundation for Education, Science and Community Development, Doha (QA)

(72) Inventors: Mashael Al Sabah, Doha (QA); Mohamed Nabeel, Doha (QA); Euijin Choo, Doha (QA); Issa M Khalil, Doha (QA); Ting Yu, Doha (QA); Wei Wang, Doha (QA)

(21) Appl. No.: 17/495,391

(22) Filed: Oct. 6, 2021

Related U.S. Application Data
(60) Provisional application No. 63/089,249, filed on Oct. 8, 2020.

(51) Int. Cl. H04W 12/121; G06F 16/901; H04W 12/30

(52) U.S. Cl. CPC H04W 12/121; H04W 12/30; G06F 16/9024

(57) ABSTRACT

A system is provided for identifying compromised mobile devices from a network administrator's point of view. The provided system utilizes a graph-based inference approach that leverages an assumed correlation that devices sharing a similar set of installed applications will have a similar probability of being compromised. Stated differently, the provided system determines whether a given unknown device is compromised or not by analyzing its connections to known devices. Such connections are generated from a small set of known compromised mobile devices and the network traffic data of mobile devices collected by a service provider or network administrator. The proposed system is accordingly able to reliably detect unknown compromised devices without relying on device-specific features.

### PRIORITY CLAIM

The present application claims priority to and the benefit of U.S. Provisional Application 63/089,249, filed Oct. 8, 2020, the entirety of which is herein incorporated by reference.

### BACKGROUND

In view of a significant increase of online threats, there is a growing demand on Internet service providers (ISPs) by governments and organizations to have a bigger role in preventative cyber security. ISPs actively employ measures to filter spoofed traffic, but can also have a key role of detecting other attacks. One emerging attack vector that can be effectively tackled at the ISP level is the detection of compromised mobile devices. ISPs have direct access to key network traces and information, which enables them to perform early detection of compromised mobile devices. Once discovered, ISPs can inform their customers including organizations so that they can take proper actions.

Organizations have encouraged the use of personal mobile devices in workplaces, increasing the security incidents involving mobile devices. Among other undesirable behavior, such devices may leak sensitive information, perform unauthorized credit card transactions, and make phone calls. A key challenge in mitigating such security threats is to accurately detect compromised devices and take actions. As organizations have little control over mobile devices and do not have access to all mobile network traffic, one needs to perform the detection at the mobile network provider level.

A number of methods to detect malicious applications have been proposed, which mainly apply various static and dynamic code analysis techniques and network-based approaches. However, these techniques require the inspection of a vast number of applications created constantly and identify local features of every device and/or app. Another approach to detect compromised devices is to compare applications in a device against known malicious apps. However, similar to other blacklist based approaches utilized to detect malicious entities in the Internet, such an approach fails to detect compromised devices having previously unknown malicious apps. Therefore, a method that is needed to detect compromised devices that solves the above drawbacks.

### SUMMARY

The present disclosure provides new and innovative systems and methods for detecting compromised devices that utilizes a graph-based inference approach which leverages an assumed correlation that devices sharing a similar set of installed applications will have a similar probability of being compromised. In an example, a system for detecting compromised devices includes a processor in communication with a memory. The system receives information from a first device over a network, the information including application information on one or more applications installed on the first device. The system further determines, based on a graph model, whether the first device is compromised based on an association of the first device to one or more second devices. The one or more second devices has at least one application installed on the one or more second devices that is the same as the one or more applications installed on the first device. The graph model includes the first device and the plurality of second devices, and is generated from information on a plurality of second devices including the one or more second devices.

In an example, a method for detecting compromised devices includes receiving information from a first device over a network, the information including application information on one or more applications installed on the first device. The method then includes determining, based on a graph model, whether the first device is compromised based on an association of the first device to one or more second devices. The one or more second devices have at least one application installed on the one or more second devices that is the same as the one or more applications installed on the first device. The graph model includes the first device and the plurality of second devices, and is generated from information on a plurality of second devices including the one or more second devices.

In an example, a non-transitory, computer-readable medium stores instructions. The instructions, when performed by a processor, cause the processor to receive information from a first device over a network, the information including application information on one or more applications installed on the first device. It may then be determined, based on a graph model, whether the first device is compromised based on an association of the first device to one or more second devices. The one or more second devices has at least one application installed on the one or more second devices that is the same as the one or more applications installed on the first device. The graph model includes the first device and the plurality of second devices, and is generated from information on a plurality of second devices including the one or more second devices.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a system for detecting compromised devices, according to an aspect of the present disclosure.

FIG. 2 illustrates a flowchart of a method for detecting compromised devices, according to an aspect of the present disclosure.

FIG. 3 illustrates an example bipartite graph modeling an association between devices and applications, according to an aspect of the present disclosure.

FIG. 4 illustrates a graph showing the cumulative distribution function (CDF) of the number of devices where the x-axis represents the number of devices having each application and the y-axis represents the corresponding CDF, according to an aspect of the present disclosure.

FIG. 5 illustrates a graph showing the CDF of the number of application stores where the x-axis represents the number of application stores having each application string and the y-axis represents the corresponding CDF, according to an aspect of the present disclosure.

FIG. 6 illustrates a graph that presents the number of newly detected devices with varying the size of seed for belief propagation, according to an aspect of the present disclosure.

FIG. 7 illustrates a graph showing AUC with varying ε, according to an aspect of the present disclosure.

FIGS. 8A to 8C illustrate respective graphs that show the CDF of shortest path lengths between nodes in C_{B} and C_{G}, according to an aspect of the present disclosure.

### DETAILED DESCRIPTION

Many free mobile applications are typically developed with in-application advertisements promoting other applications or in-application purchases. While using such free apps, users are often tricked to authorize the download of related applications and fall victim to drive-by download attacks. Further, many users also tend to install free applications that are not published in official application stores. For example, in some countries, users are blocked from accessing main application stores and thus have to use various other stores with weaker security practices. The present disclosure is therefore based on the insight that mobile devices with a similar array of installed applications will likely have a similar probability of being compromised. Based on this insight, the present disclosure provides a method for detecting compromised mobile devices on a network from the perspective of a network administrator.

The provided method is a graph-based inference approach that leverages an assumed correlation that devices sharing a similar set of installed applications will have a similar probability of being compromised. Stated differently, the provided method determines whether a given unknown device is compromised or not by analyzing its connections to known devices. Such connections are generated from a set of known compromised mobile devices and the network traffic data of mobile devices collected by a service provider or network administrator. The provided method is accordingly able to reliably detect unknown compromised devices without relying on device-specific features (e.g., device model, OS version, application versions, or application types such as phishing, malware, etc.). The provided method can also detect compromised devices at large-scale without time-consuming investigation on individual devices.

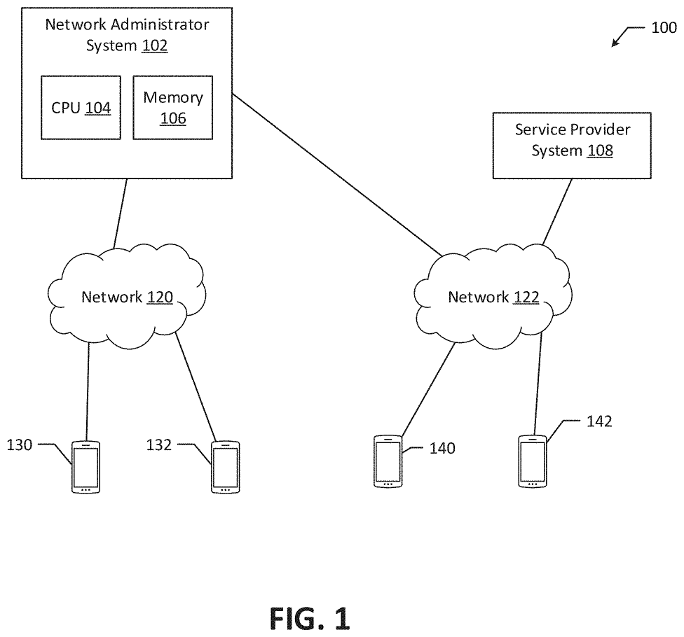

FIG. 1 illustrates an example system 100 for detecting compromised devices. In at least some aspects, the system 100 may include a network administrator system 102 in communication with a service provider system 108 over a network 122. The network administrator system 102 may be, for example, one or more network servers in enterprise networks with which an administrator has full visibility of user activities, such as a DHCP server, a DNS server, a proxy server, or another suitable server of an organization or company that devices (e.g., user devices 130, 132) of members of the organization or company connect to (e.g., over a network 120). In at least some aspects, the network administrator system 102 may include a processor in communication with a memory 106. The processor may be a CPU 104, an ASIC, or any other similar device. In other examples, the components of the network administrator system 102 may be combined, rearranged, removed, or provided on a separate device or server. The service provider system 108 may be any suitable Internet service provider that provides Internet access to user devices (e.g., the user devices 140, 142) via fiber-optics, satellite, copper wire, etc. The network 122 can include, for example, the Internet or some other data network, including, but not limited to, any suitable wide area network or local area network.

The network administrator system 102 may be in communication with multiple user devices 130, 132 over a network 120. Each of the user devices 130, 132 may be any type of device capable of communicating over a network including a smartphone (e.g., FIG. 1), a cellular phone, a tablet computer, a laptop computer, a workstation, smart-eyewear, smartwatch, etc. At least some of the user devices 130, 132 include installed applications. The network 120 can include, for example, the Internet or some other data network, including, but not limited to, any suitable wide area network or local area network. In various examples, the network 120 may be an internal network of the organization or company including the network administrator system 102.

The service provider system 108 may provide Internet access to multiple user devices 140, 142 over the network 122. Each of the user devices 140, 142 may be any type of device capable of communicating over a network including a smartphone (e.g., FIG. 1), a cellular phone, a tablet computer, a laptop computer, a workstation, smart-eyewear, smartwatch, etc. At least some of the user devices 140, 142 include installed applications. In various aspects, the service provider system 108 may collect and store network traffic data of activity performed by each of the user devices 140, 142 over the network 122. For example, the network traffic data may include IP packets generated by the network usage behavior of the user device 140, such as for each of the installed applications on the user device 140 and for communications between user devices (e.g., between the user devices 140 and 142). In at least some aspects, the service provider system 108 may communicate the network traffic data to the network administrator system 102 over the network 122. The network administrator system 102 may utilize the network traffic data from the service provider system 108 to detect whether any user devices 130, 132 in communication with the network administrator system 102 over the network 120 are compromised.

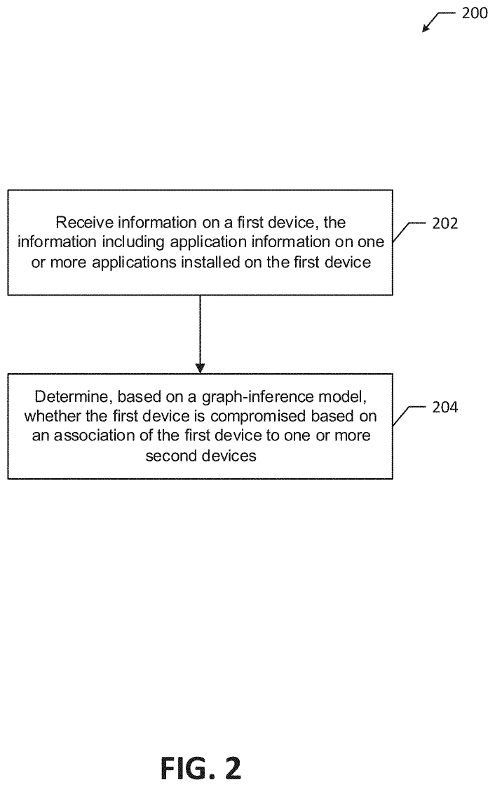

FIG. 2 shows a flow chart of an example method 200 for detecting whether an unknown user device is compromised. Although the example method 200 is described with reference to the flowchart illustrated in FIG. 2, it will be appreciated that many other methods of performing the acts associated with the method 200 may be used. For example, the order of some of the blocks may be changed, certain blocks may be combined with other blocks, and some of the blocks described are optional. The method 200 may be performed by processing logic that may comprise hardware (circuitry, dedicated logic, etc.), software, or a combination of both. For example, the memory 106 may store processing logic that the processor of the network administrator system 102 executes to perform the example method 200.

The example method 200 may include receiving information on a first device (e.g., the user device 130) that includes information on one or more applications installed on the first device (block 202). For example, the network administrator system 102 may receive information from the user device 130 that details the one or more applications installed on the user device 130. In various aspects, the information on the one or more installed applications may include an application name, application developer, application hash code, version history, quantity of downloads, publication date or year on an application store, or other suitable information for identifying an application.

The network administrator system 102 may then determine, based on a graph model, whether the user device 130 is compromised based on an association of the user device 130 with one or more second devices (e.g., the user device 140) (block 204). The user device 140 has at least one application installed on the user device 140 that is the same as the one or more applications installed on the user device 130. For example, the user devices 130 and 140 may both have the same malicious application installed.

The graph model may be generated based on the inventors' insight that there exists an association between a device and its installed applications following homophily that can be used to identify compromised devices. Mobile users typically access content through the applications installed on their devices. If a device installs malicious applications, it is likely to download/install other malicious applications, for example due to in-application advertisements promoting similar applications and other drive-by-download attacks. Additionally, most applications require network connection between devices and their host servers while being downloaded, installed, or executed. The inventors have therefore found that the likelihood of a device being compromised can be measured by analyzing its application usage behavior revealed in network traffic data of a service provider. In some aspects, the graph model may be a bipartite graph.

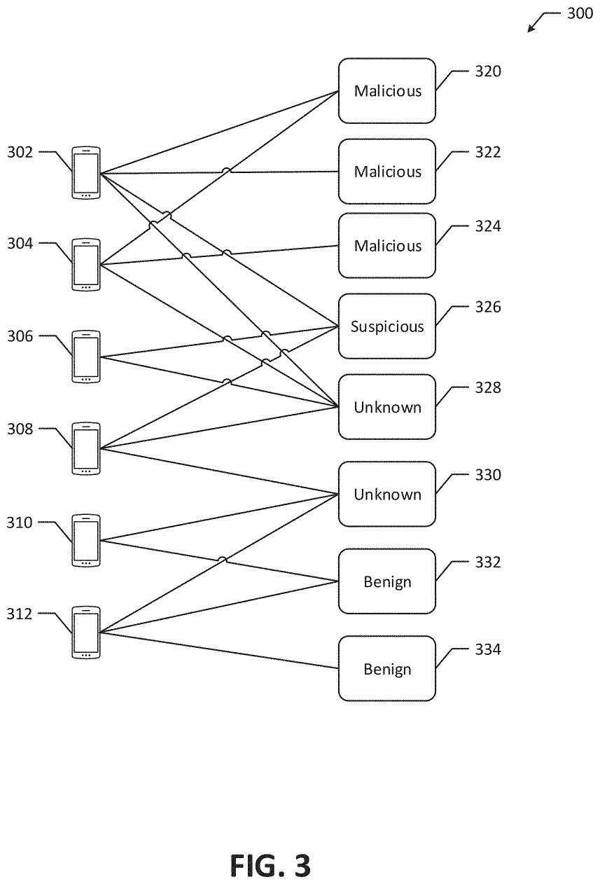

In an example, to construct a bipartite graph, associations between devices and applications may be represented as a bipartite graph G=(V,E) where a set of devices D={d₁ . . . dₙ}⊂V and a set of applications A={a₁, . . . aₙ}⊂V are connected with undirected edges e(dᵢ,aⱼ), where dᵢ is a device and aⱼ is an app. FIG. 3 illustrates an example model bipartite graph 300 in which the left side is a set of devices 302-312 (i.e., the nodes in D) and the right side is a set of applications 320-334 (i.e., the nodes in A). In various aspects, each device 302-312 (e.g., each node in D) may belong to one of three categories: not-compromised, compromised, and unknown. In this example, the devices 302 and 304 are compromised, the devices 306 and 308 are unknown, and the devices 310 and 312 are not-compromised. In various aspects, each application 320-334 (e.g., each node in A) may belong to one of four categories: benign, malicious, suspicious, and unknown. In this example, the applications 320, 322, and 324 are malicious, the application 326 is suspicious, the applications 328 and 330 are unknown, and the applications 332 and 334 are benign.

Each illustrated connection between a device 302-312 and an application 320-334 is an edge in the example model bipartite graph 300. As illustrated, the compromised devices 302 and 304 may have edges with the malicious applications 320-324, the suspicious application 326, and the unknown application 328. In other examples, the compromised devices 302 and 304, additionally or alternatively, may have one or more edges with the benign applications 332, 334. Stated differently, a compromised device 302, 304 may have edges with all types of applications. The unknown devices 306 and 308 may have edges with the suspicious application 326, and the unknown applications 328 and 330. In other examples, the unknown devices 306 and 308 may have one or more edges with the benign applications 332, 334. Stated differently, and unknown device 306, 308 may have edges with suspicious, unknown, and benign applications. The not-compromised devices 310 and 312 may have edges with the benign applications 332, 334 and the unknown application 330, but do not have edges with suspicious or malicious applications.

In at least some aspects, the bipartite graph 300 may be constructed using entities, including devices and applications, extracted from network traffic collected by the service provider system 108 and communicated to the network administrator system 102. In various aspects, the entities may be extracted from fields in IP packets in the network traffic. Each IP packet may include an IP layer with a source IP address and an application layer with an application string (HTTP) or TLS Certificate (HTTPS). In such aspects, the application string and certificate may be used to extract application information, whereas the source IP addresses may be used to extract device information.

In one example, each source IP address may be considered a device in order to extract a device from the network traffic. Note, however, that multiple devices may use the same IP address. Further, one device may not use the same IP address across multiple days due to the dynamics of mobile IP addresses. In some examples, therefore, a packet daily timestamp along with the source IP address may define a device (e.g., 10.x.x.x_2021_08_01).

In some aspects, to extract application information revealed in HTTP headers, the IP packets containing the application string field in the header may be extracted. It at least some instances, each unique application string may be treated as corresponding to an application. In some aspects, to extract application information revealed in HTTPS traffic, server certificates may be extracted to identify corresponding applications. The serial number is unique for each certificate issued by a Certificate Authority, and therefore, in some aspects, each serial number may be considered an application. In various instances, cruise certificates may be filtered out and non-cruise certificates may be identified that are uniquely associated with a single domain. The inventors have observed that, to create a unique application name, application developers often use the reverse domain name of the host domain (e.g., com.youdao.dict is an application hosted in dict.youdao.com) or the apex of the host domain (e.g., meipai is an application hosted in meipai.com). As such, in some aspects, for each certificate serial number identified, the certificate serial number may be further inspected to determine if the reversed domain name or apex name associated with the certificate matches any of the extracted application strings. If so, the certificate serial number may be replaced with the application string; otherwise, the certificate serial number is treated as an application string.

While an application may communicate with various sets of destination IP addresses depending on the usage, it has been shown that each application often has a unique set of destination IP addresses used only for the application. For those applications used by more than one device (e.g., the inventors found this to be 70% of the total applications), the set of destination IP addresses may be compared to compute a pairwise similarity of traffic patterns among devices having the same app. In doing so, the destination IP addresses that are used for multiple applications may be filtered. Then, a similarity between two devices for an application may be measured by the number of the common destination IP addresses over the total number of destination IP addresses used for the application. An average traffic similarity of an application may then be defined by the average of pairwise similarities for the applications. For example, assume traffic is observed in which three devices have an application called com.app.string. Given the traffic, the similarity values between a first device and a second device are 3/4=0.75; between the second device and a third device are 3/4=0.75; and between the first device and the third device are 4/4=1. Then, the average traffic similarity of the application, com.app.string, is (0.75+0.75+1)/3=0.833.

The inventors observed that 70% of applications among those used by multiple devices had similarities above 0.5. Note that an application with a low similarity such as 0.3 does not necessarily mean that the application is not correctly identified, because a certain application may have different traffic patterns on each device. As such, applications with a low similarity are not necessary filtered out. For example, in some aspects, applications with a similarity lower than a predetermined threshold τsim may be filtered. The predetermined threshold may be adjusted depending on preference (e.g., false positive or false negatives).

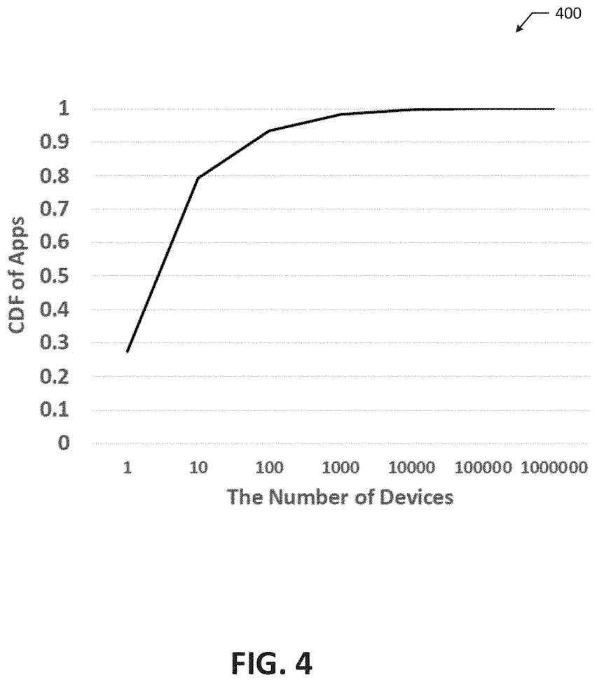

FIG. 4 illustrates a graph 400 showing the cumulative distribution function (CDF) of the number of devices the inventors found when validating the presently disclosed system where the x-axis represents the number of devices having each application and the y-axis represents the corresponding CDF (i.e., the portion of apps). The inventors found that nearly 30% of applications had only one device. This is mainly because application strings may also include version or market names of the applications such as com.sina.news-7.19.3 and com.supercell.clashofclans.baidu, which the inventors considered as individual apps.

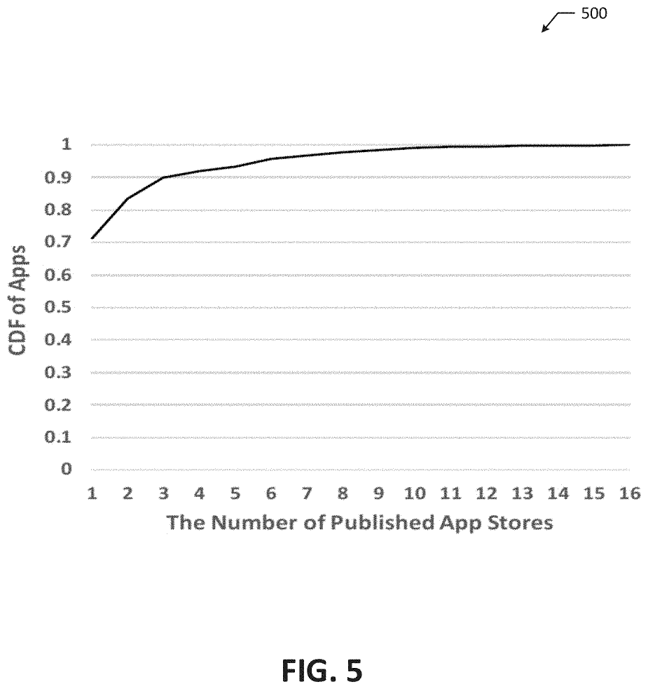

A mapping between the devices and applications (e.g., either application strings or certificate serial numbers), i.e. edges, may then be generated from the extracted information. In at least some aspects, in order to generate the graph model, such as the bipartite graph 300, a ground truth set must be built. Various intelligence sources may be used to build a ground truth set for applications. In one example, VirusTotal, a security intelligence portal for IPs, URLs and binaries, based on third-party anti-virus engines, may be used to collect a ground truth set for applications. FIG. 5 illustrates a graph 500 showing the CDF of the number of application stores the inventors found when validating the presently disclosed system where the x-axis represents the number of application stores having each application string and the y-axis represents the corresponding CDF (i.e., the portion of apps). The inventors found that 29% of application strings were published in multiple application stores, as shown in FIG. 5. However, the inventors observed that the maliciousness of each application was the same regardless of the application stores where it was downloaded.

To reduce potential false positives, the inventors labeled each application in the ground truth set using thresholds as follows: if an application was detected as malicious by more than or equal to vt number of engines among the 60 VT engines, the application was labeled as bad; if an application was detected as malicious by less than vt engines, the application was labeled as suspicious; if an application was not detected as malicious by any engine, the application was labeled good; if no corresponding binaries were found, the application was labeled as no-info.

Many application stores are known to perform a vetting process to identify and remove malicious applications from the stores. As it is relatively easy to detect popular yet bad applications through such a general vetting process, the inventors excluded popular applications and application libraries from the ground truth set. The inventors considered an application popular if it was used by more than a threshold Nₚ number of devices (e.g., between 1,000 and 10,000 devices). This filtering helped avoid a number of false positives which can be induced by false association in a graph-based approach.

Additionally, unbalanced initial scores lead to a biased set (e.g., good devices) dominating the final scores, which is undesirable as the provided method 200 aims to detect bad, compromised devices. In various aspects, good devices may be down-sampled, meaning that a random number of good devices may be chosen to equal the number of bad devices. For example, there may be 48999 good devices and 2153 bad devices if vt=5 and Nₚ=1000. In such an example, all 2153 bad devices may be used as the set of bad devices D_{B} and 2153 good devices may be randomly chosen from the 48999 good devices as the set of good devices D_{G}. The random sampling process may be repeated a number of times to avoid any bias possibly occurred specific set of samples. For example, the number of times the random sampling process is repeated may be equal to the number of good devices N(D_{G}) divided by the number of good devices in the sample size N(D_{G}^{s}). The number of good devices in the sample size is equal to the number of bad devices N(D_{B}), as described above. One or more fold cross validations may then be performed with each of the samples. The average of each performance measure may then be computed. An example algorithm for performing this balancing of the ground truth set is shown as Algorithm 1 below.

1: for i=1 to n do

2: Create D_{G}^{s} by randomly choosing samples of good devices with the size of N(D_{G}^{s})

3: KFoldCrossValidation(D_{B},D_{G}^{s})

4: end for

5: Average TPR (Recall), FPR, Precision from iteration

### Algorithm 1

1: Split B and G into k folds, ∪ⱼ₌₁^{k}Fⱼ

2: for j=1 to k do

3: Set Fⱼ as a testing set, TEST

4: Set remaining k−1 folds as a training set, TRAIN

5: RunGraphInterference(TRAIN, TEST)

6: Compute TPR (Recall), FPR, Precision and the testing set

7: end for

8: Average TPR (Recall), FPR, Precision from iteration

### Algorithm 2

1: Initialize the scores of devices in TRAIN according to their labels (good/bad)

2: Initialize the scores of the rest of the nodes in the graph as 0.5

3: Run the graph inference algorithm

4: Classify the TEST devices based on their final score after convergence

### Algorithm 3

Given the set of bad devices and sampled good devices, k fold cross validation may be performed. Specifically, in at least some aspects, each of the groundtruth sets (balanced) may be randomly divided into k folds and Algorithm 2 shown above may be run k times. In each run, one fold may be used as a testing set and the remaining k−1 folds may be used as a training set. Then, Algorithm 3 shown above may be run to get the final scores of all nodes. Devices in the testing set are classified based on their final scores. Specifically, a predetermined threshold for the final score may be set, and a device whose final score is above the threshold may be classified as bad; otherwise, the device may be classified as good. The predetermined threshold may vary in different aspects. A true positive rate (TPR) may be computed as the number of bad devices correctly classified to the total number of bad devices in the test set. The false positive rate (FPR) is computed as the number of good devices that are misclassified to the total number of good devices in the test set.

Given the ground truth set for applications above, the inventors defined a bad device as one using more than or equal to N(A_{b}) number of bad applications, where A_{b} is the set of bad applications. A good device was defined as one not using any bad or suspicious apps. With consideration of noise of VT, N(A_{b})=2 was used as default.

Returning to the example method 200 of FIG. 2, based on the graph model (e.g., the bipartite graph 300), the guilt-by-association principle may be applied to determine whether the user device 130 is compromised. The idea of guilt-by-association is to estimate the guiltiness of a node by propagating prior knowledge on some of the nodes in the graph model, given the homophily relationship between nodes. The inventors have found that the more malicious applications a device has, the more likely it is to download other malicious applications, resulting in homophily relationships between devices and applications. To apply the guilt-by-association principle, in various aspects, an inference algorithm may be executed on the bipartite graph 300 to determine whether the user device 130 is compromised. For example, the inference algorithm may be label propagation, belief propagation, or graph node embedding along with a downstream classifier, each of which is well known in the state of the art. Each of these example inference algorithms takes a small set of known compromised or benign devices as input and accordingly assigns labels to them. Through an iterative process, each of the example inference algorithms propagate the labels to connected applications and devices in the graph and predict the status of unknown devices based on the propagated information.

In one particular example, a belief propagation inference algorithm may be employed to determine whether the user device 130 is compromised based on the bipartite graph 300. The effectiveness of belief propagation depends on the strength of association between nodes in the graph it is applied to. Unlike other applications where associations are relatively straightforward to be derived (e.g., a malware-infected machine and its activity controlled by command & control servers), it can be challenging to derive such strong associations between devices and mobile applications due to the fact that: (1) it is often difficult for mobile applications to interfere and taint other applications; and (2) user interactions are needed to take any action. The provided method 200 overcomes these challenges through the inventors' derivation of the association that mobile devices with a similar array of installed applications will likely have a similar probability of being compromised.

When employing a belief propagation inference algorithm with the bipartite graph 300, in various aspects, each node i∈V may be modeled as a random variable, xᵢ, that can be in the set of state S={good, bad} so that the badness and goodness of a node can be expressed by the probabilities P(Bad) And P(Good), respectively, where P (Bad)+(Good)=1. The marginal probabilities P(xᵢ=Good) and P(xᵢ=Bad) for unknown devices may then be determined. The belief propagation algorithm computes the marginal probability of each node by iteratively passing local messages from its neighbor given the prior knowledge of other nodes in the graph.

At each iteration, the belief propagation algorithm computes the message vector mᵢⱼ for each node i, and passes it to each of its neighbors j∈N(i), where N(i) is the set of i's neighbor. mᵢⱼ(xⱼ) is i's belief that node j is in state xⱼ (i.e., i's outgoing message vector to j), which will be computed based on i's neighbors' messages about i. Concretely, there are three components to compute message mᵢⱼ(xⱼ): (1) initial belief ϕᵢ(xᵢ) for i being in state xᵢ; (2) the product of all messages mₖᵢ(xᵢ) from i's neighbors excluding j (i.e., i's incoming message vector from k∈N(0); and (3) the edge potential ψᵢⱼ(xᵢ,xⱼ) between two neighboring nodes i and j specifying the probability of i being in state xᵢ and j being in state xⱼ. Formally, the message is defined by Equation 1 below.

$${m}_{i j} ( {x}_{j} ) = {\sum }_{{x}_{i} ∈ S} [ {ϕ}_{i} ( {x}_{i} ) {ψ}_{i j} ( {x}_{i} , {x}_{j} ) {\prod }_{k ∈ N ( i ) ∖ j} {m}_{k i} ( {x}_{i} ) ] \qquad Equation 1.$$

The initial belief is assigned for each node based on the ground truth labels, which is summarized in Table 1 below. Further, Table 2 below represents the edge potential (ε) matrix.

TABLE 1

| | P(Bad) | P(Good) |
|---|---|---|
| Bad | δ | 1-δ |
| Good | 1-δ | δ |
| Unknown | 0.5 | 0.5 |

TABLE 2

| | Bad | Good |
|---|---|---|
| Bad | ε | 1-ε |
| Good | 1-ε | ε |

The inventors found that the results of the provided network administrator system 102 were sensitive to ε. As ε increased, the false positive rates increased. The inventors found that low values of c resulted in the highest accuracy for the network administrator system 102. In an example, c is equal to 0.51.

The belief propagation algorithm is not theoretically guaranteed to converge for arbitrary graphs. However, it is shown to converge quickly with highly accurate approximation in practice. After the messages converge, i.e. they do not change significantly between iterations, the final belief for i may be computed according to Equation 2 below, where bᵢ[xᵢ] is the probability score for a device to be compromised or not, C is a normalizing constant, ϕ(xᵢ) is the belief for i being in state xᵢ, and mₖᵢ(xᵢ) is a messages from one of i's neighbors. The user device 130 may be determined to be compromised or not-compromised based on the final belief. For example, if the computed final belief is greater than a threshold value, then the user device 130 is determined to be compromised, whereas if the final belief is less than or equal to the threshold value, then the user device 130 is determined to be not-compromised.

$${b}_{i} [ {x}_{i} ] = C ϕ ( {x}_{i} ) {\prod }_{k ∈ N ( i )} {m}_{k i} ( {x}_{i} ) , \qquad Equation 2.$$

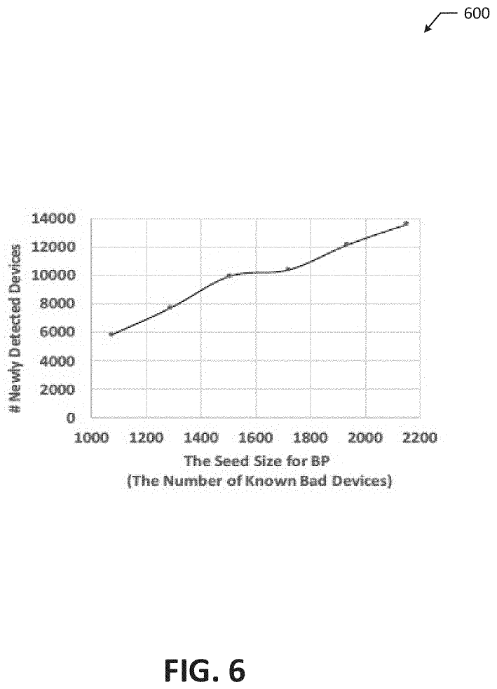

FIG. 6 illustrates a graph 600 that presents the number of newly detected devices (the y-axis) with varying the size of seed (the training ground truth) for belief propagation (the x-axis). The inventors found that there was no significant difference in true positive rate (TPR) and false positive rate (FPR) with different seed sizes. As FIG. 6 shows, the provided network administrator system 102 detected about 6 to 7 times as many unknown bad devices not in the ground truth set. The inventors demonstrated that these newly detected devices indeed showed undesirable behavior in terms of their privacy leakage and network infrastructure accessed.

The inventors additionally investigated why edge potential value E has an impact on the results of the provided network administrator system 102, by providing in-depth analysis on distinctive network properties of two bipartite graphs from different applications. In the first graph (Mobile), E has obvious impact on accuracy, while in the other (DNS), E has no notable impact on accuracy. Mobile represented the bipartite graph built from the inventors' dataset. Various ground truth sets were used while changing vt to define a bad device, which had no significant impact on false positive rates and true positive rates. Nodes in the ground truth drawn with different vts were not found to have much topological difference. Without loss of generality, the ground truth drawn with vt=5 was used to provide analysis in the following. DNS represented the bipartite graph between domains and IPs built from a known active DNS dataset in which domains and IPs were connected with edges, each of which represented a domain resolving to an IP.

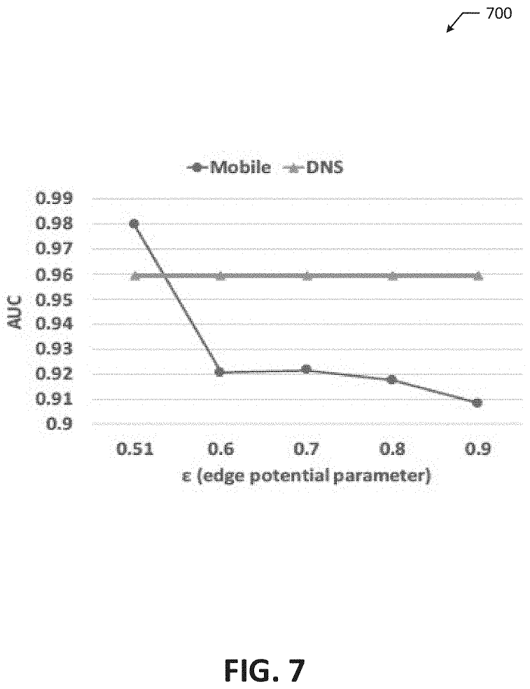

To clearly capture the sensitivity to E in each of the two graphs (Mobile and DNS), the area under the ROC curve (AUC) was measured. FIG. 7 illustrates a graph 700 showing AUC with varying ε, where the x-axis represents E and the y-axis represents the corresponding AUC for each graph. The graph 700 shows that the classification accuracy in Mobile gets lower (from 0.98 to 0.91), as E is increased by 0.1 (0.51, 0.6, 0.7, 0.8, 0.9). On the other hand, the classification accuracy in DNS stays almost the same (0.96), regardless of E. The inventors found that this different behavior of BP is due to the network structures and the topological locations of nodes in the ground truth.

For any two nodes S and T in the graph, their impact on each other depends on multiple variables, the most important of which are: (1) the length of the path between S and T, (2) the number of paths between S and T, and (3) the edge potential parameter E. First, the longer the path between S and T, the smaller S's impact on T. This is because the edge potential diminishes as it travels on the path between the two nodes (due to fraction multiplications as many as the length of the path.) As a result, the final badness score will be insensitive to E in case of graphs with longer paths.

Second, the larger the number of paths between S and T, the higher the impact of S on T. This is because the final belief at T is a function of the product of messages received on each path from S to T. For example, assume that a bad node S has p paths to T, then S sends a bad message m_{B}(i) and a good message m_{G}(i) on a path i. Since S is bad, m_{B}(i) is larger than m_{G}(i). The final bad (good) impact of S on T is a function of the product of the m_{B}(i) m_{G}(i)) messages from all the p paths. The larger the number of paths (p), the higher the difference between the m_{B}(i) product and the m_{G}(i) product, and hence, the higher the final badness score (due to the assumption that S is bad in the example).

Finally, if ε=1, the path length will no longer have any impact, because length-1 has the same impact as length-1000. If ε is set close to 0.5, b_{S}'s impact on b_{T} greatly diminishes except for very short paths (e.g., 2).

The inventors additionally compared two datasets from the two graphs (Mobile and DNS) in terms of their topological features that has impact on belief propagation output. Specifically, the inventors investigated nodes in the ground truth set. Consider two clusters: bad (C_{B}) and good (C_{G}). The important intuition behind BP using homophily relationship is that each cluster's intra-cluster distance is supposed to be low, whereas inter-cluster distance between two clusters is supposed to be high. The inventors thus measured the intra-cluster and inter-cluster distances in terms of the shortest path lengths between all pair of nodes in C_{B} and C_{G}. The range of path lengths between nodes in C_{B} and C_{G} were from 0 to 20. The inventors made a few observations. First, generally in both datasets, intra-cluster distances are smaller than inter-cluster distances between C_{B} and C_{G}. Second, C_{B}'s intra-cluster distances are the lowest in both datasets. Finally, the difference between intra-cluster and inter-cluster distances in DNS is much larger than that in Mobile.

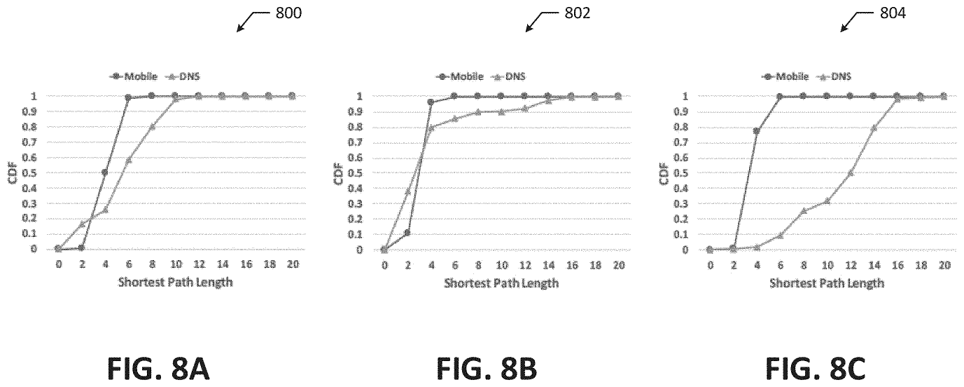

FIGS. 8A to 8C illustrates graphs 800, 802, and 804, respectively, that present the CDF of shortest path lengths between nodes in C_{B} and C_{G}, where the x-axis represents the shortest path lengths and the y-axis represents the corresponding CDF (i.e., portion of node pairs). As shown in FIG. 9, the maximum lengths are 8 and 20 in Mobile and DNS, respectively. The difference of C_{B}'s intra-cluster distances between Mobile and DNS is relatively small in the two datasets. Specifically, 96.2% of path lengths are within 4 (i.e., 2 or 4) in Mobile, and 79.9% of path lengths are within 4 in DNS.

On the other hand, the inventors observed different characteristics in C_{G}'s intra-cluster distances, and inter-cluster distance between C_{B} and C_{G} for each dataset. In Mobile, 98.7% of path lengths between nodes in C_{G} are smaller than or equal to 6 and only 1.3% of path lengths are greater than 6; which are in fact similar to the inter-cluster distance between C_{B} and C_{G} where 99.8% of path lengths are smaller than or equal to 6 and only 0.2% of path lengths are greater than 6. In DNS, 60% of path lengths between nodes in C_{G} are smaller than or equal to 6, while 90% of path lengths between nodes in C_{B} and C_{G} are more than 6. In other words, although the intra-cluster distance is smaller than the inter-cluster distance in both datasets (i.e., the homophily relationships holds), the difference between intra-cluster and inter-cluster distances in Mobile is relatively small. By contrast, the difference is relatively large in DNS. On average, differences between C_{B}'s intra-cluster distance and the inter-cluster distance was only 0.6 in Mobile, whereas the difference is 8 in DNS, as shown in Table 3 below.

TABLE 3

| | Good-Good | Bad-Bad | Bad-Good |
|---|---|---|---|
| Mobile | 5.016 | 3.857 | 4.448 |
| DNS | 6.43 | 4.523 | 12.062 |

Recall how the path length and 6 affect the behavior of belief propagation. Relatively long inter-cluster distance (i.e., 12) diminishes the impact of bad (good) domains on good (bad) domains, irrespective of ε in DNS. On the other hand, ε plays a big role in classification accuracy in Mobile, due to the small differences between intra-cluster and inter-cluster distances. Concretely, bad devices have more impact on good ones when a higher E was used, resulting in the higher false positives. Hence, the inventors found it beneficial, in at least some aspects, to choose E close to 0.5 (e.g., 0.51) to avoid high false positives.

The closeness centrality (CC) of a node measures the average length of the shortest paths from the node μ to others, and is computed according to Equation 3 below where N is the number of nodes in the graph and l(v,u) is the shortest path length between u and node v.

$$C {C}_{u} = ( N - 1 ) / {\sum }_{v} l ( v , u ) , \qquad Equation 3.$$

Essentially, CC takes into account both factors: the number of paths and the shortest path lengths. If all nodes in the graph are highly connected to each other with short path lengths, the CCs of all nodes will be similar. Indeed, the average CCs of bad and good devices in Mobile were similar (0.229 and 0.204) as shown in Table 4 below. On the other hand, the average CC of bad domains was relatively small (0.088), compared to those of good and unknown domains (0.141 and 0.113, respectively) in DNS. Along with the average shortest path given in Table 3, the inventors concluded that the bad nodes in DNS are much farther from other nodes and have less number of paths to other nodes, while good nodes are highly connected to good or unknown nodes, which is expected. This is because good domains are not likely to have many connections to bad domains, but have many connections to good or unknown domains. Hence, the classification accuracy is not sensitive to ε in in DNS.

TABLE 4

| | Closeness | Eigenvector |
|---|---|---|
| | Centrality | Centrality |
| Mobile(Bad) | 0.229 | 0.03 |
| Mobile (Good) | 0.204 | 0.01 |
| Mobile (Unknown) | 0.212 | 0.021 |
| DNS (Bad) | 0.088 | 0.005 |
| DNS (Good) | 0.141 | 0.179 |
| DNS (Unknown) | 0.113 | 0.006 |

The eigenvector centrality (EC) of a node μ measures its influence in the graph, and is computed according to Equation 4 below where v is u's neighbor, A is the adjacency matrix of the graph, K₁ is its largest eigenvalue.

$$E {C}_{u} = {κ}_{1}^{- 1} {\sum }_{v} {A}_{u v} E {C}_{v} . \qquad Equation 4.$$

A node with high EC means that it is highly connected to other influential nodes. That is, messages are most frequently passing through a node with high EC so that it will play a key role during belief propagation process. As shown in Table 4, there is clear difference on ECs between Mobile and DNS graphs. In general, the average ECs of bad, good, and unknown devices were almost similar (i.e., 0.03, 0.01, 0.021, respectively) in Mobile graph. This means that all nodes in the graph are highly connected with each other so that there are no significantly influential nodes in the graph. Note that the ECs of bad devices was the highest, meaning that as the higher 6 is used, the score of bad devices can dominate the network, resulting in high false positives. On the other hand, the average EC of good domains (0.179) were much higher than those of bad and unknown domains (0.005 and 0.006, respectively) in DNS graph.

Similar to results from CC, bad domains in DNS were significantly further from other nodes and are not connected to influential nodes, meaning that there was a smaller number of paths to other nodes. Although the ECs of good domains were high on average, they are well-distributed. This is in fact expected, as there can be influential and non-influential domains.

By the inventors' definition in Mobile, bad devices can have edges with all types of applications (i.e., bad, good, suspicious, and no-info apps), and good devices can have edges with good and no-info applications. This means that good devices could have a similar number of paths with both good and bad devices; bad devices, however, have more paths with other bad devices than good devices. Consequently, bad devices become relatively influential and connected to other influential bad devices, resulting in the relatively high ECs.

Recall how the number of paths and E affect the behavior of belief propagation. The inventors observed that bad devices are more influential on others than good devices in Mobile, whereas bad domains are less influential on others in DNS. Along with results in Table 3, the inventors concluded that bad devices get more influences from bad devices, especially from those influential bad devices, than good devices such that good devices' messages have relatively less impact on bad devices. Consequently, there are not much change on false negatives, irrespective of E, as opposed to false positives.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

The invention is claimed as follows:

1. A system for detecting compromised devices, the system comprising:
a memory; and
a processor in communication with the memory, the processor configured to:
receive information from a first device over a network, the information including application information on one or more applications installed on the first device; and
determine, based on a graph model, whether the first device is compromised based on an association of the first device to one or more second devices, the one or more second devices having at least one application installed on the one or more second devices that is the same as the one or more applications installed on the first device, wherein the graph model is generated from information on a plurality of second devices including the one or more second devices, and wherein the graph model includes the first device and the plurality of second devices.

2. The system of claim 1, wherein the graph model is a bipartite graph.

3. The system of claim 2, wherein the bipartite graph consists of a first node type for applications and a second node type for devices.

4. The system of claim 2, wherein the bipartite graph includes a set of devices and a set of applications, each of the set of devices and the set of applications including a plurality of nodes, and the set of devices and the set of applications being connected with undirected edges.

5. The system of claim 4, wherein each node in the set of applications is categorized as one of the group consisting of benign, malicious, suspicious, and unknown, and wherein each node in the set of devices is categorized as one of the group consisting of not-compromised, compromised, and unknown.

6. The system of claim 1, wherein the processor is configured to determine whether the first device is compromised based on the graph model using one of the group consisting of label propagation, belief propagation, and graph node embedding.

7. The system of claim 1, wherein the processor is configured to determine whether the first device is compromised based on the graph model using belief propagation.

8. The system of claim 1, wherein the information on the plurality of second devices includes network traffic data from an internet service provider.

9. The system of claim 1, wherein the first device and each of the one or more second devices are mobile computing devices.

10. The system of claim 1, wherein the one or more applications installed on the first device are malicious.

11. The system of claim 1, wherein it is determined, based on a graph model, whether the first device is compromised based on the below equation:
$${b}_{i} [ {x}_{i} ] = C ϕ ( {x}_{i} ) {\prod }_{k ∈ N ( i )} {m}_{k i} ( {x}_{i} ) , \qquad$$
wherein
bᵢ[xᵢ] is a probability score for a device to be compromised or not;
C is a normalizing constant,
ϕ(xᵢ) is a belief for i being in state xᵢ, and
mₖᵢ(xᵢ) is a message from one of i's neighbors.

12. The system of claim 11, wherein the first device is determined to be compromised in response to bᵢ[xᵢ] being greater than a predetermined threshold value.

13. The system of claim 12, wherein the graph model includes one or more first nodes for applications and one or more second nodes for devices, wherein the one or more first nodes are determined from the application string and the TLS certificate and the one or more second nodes are determined from the source IP.

14. The system of claim 1, further comprising an internet service provider system in communication with the processor over a network.

15. A method of detecting compromised devices comprising:
receiving information from a first device over a network, the information including application information on one or more applications installed on the first device; and
determining, based on a graph model, whether the first device is compromised based on an association of the first device to one or more second devices, the one or more second devices having at least one application installed on the one or more second devices that is the same as the one or more applications installed on the first device, wherein the graph model is generated from information on a plurality of second devices including the one or more second devices, and wherein the graph model includes the first device and the plurality of second devices.

16. The method of claim 15, wherein the graph model is a bipartite graph, wherein it is determined whether the first device is compromised based on the bipartite graph by calculating, via belief propagation, a probability of the first device being compromised and determining that the first device is compromised if the calculated probability is greater than a predetermined threshold.

17. The method of claim 15, wherein the graph model is generated from network traffic data received from a network service provider over a network.

18. A non-transitory, computer-readable medium storing instructions, which when executed by a processor, cause the processor to:
receive information from a first device over a network, the information including application information on one or more applications installed on the first device; and
determine, based on a graph model, whether the first device is compromised based on an association of the first device to one or more second devices, the one or more second devices having at least one application installed on the one or more second devices that is the same as the one or more applications installed on the first device, wherein the graph model is generated from information on a plurality of second devices including the one or more second devices, and wherein the graph model includes the first device and the plurality of second devices.

19. The non-transitory, computer-readable medium storing instructions of claim 18, wherein the graph model is constructed from an IP packet extracted from network traffic data of an internet service provider, the IP packet including a source IP, an application string, and a TLS Certificate.

20. The non-transitory, computer-readable medium storing instructions of claim 18, wherein the information received from the first device includes one or more of an application name, application developer, application hash code, version history, quantity of downloads, and publication date or year on an application store.
